(19) United States
(12) Patent Application Publication
(10) Pub. No.: US 2007/0088800 A1
(43) Pub. Date: Apr. 19, 2007

(54) Browsing email addresses

(76) Inventor: Michael J. Ure, Cupertino, CA (US)

Correspondence Address: MICHAEL J. URE, 10518 PHIL PLACE, CUPERTINO, CA, 95014, US

(21) Appl. No.: 11/397,253

(22) Filed: Apr. 3, 2006

Related U.S. Application Data
(60) Provisional application No. 60/727,178, filed on Oct. 14, 2005.

(51) Int. Cl. G06F 15/16

(52) U.S. Cl. 709/217; 709/206

(57) ABSTRACT

The present invention, generally speaking, takes advantage of the currency of email addresses by making them browseable, thereby providing ready access to a personal web page of the owner of the email address.

This application is a continuation-in-part of Ser. No. 60/727,178, filed Oct. 14, 2005, incorporated herein by reference.

### BACKGROUND OF THE INVENTION

1. Field of the Invention

The present invention relates to web browsing and personal web pages.

2. State of the Art

Email has proven to be the “killer app” of the internet and a prolific productivity tool. As a result, email addresses have significant “currency;” that is, people tend to remember them or at least record them. Personal web pages are increasing in popularity. However, such web pages are often not easy to find.

### SUMMARY OF THE INVENTION

The present invention, generally speaking, takes advantage of the currency of email addresses by making them browseable, thereby providing ready access to a personal web page of the owner of the email address.

### BRIEF DESCRIPTION OF THE DRAWING

The present invention may be further understood from the following description in conjunction with the appended drawing. In the drawing:

FIG. 1 is a diagram illustrating an exemplary embodiment of the invention;

FIG. 2 is a diagram illustrating an exemplary embodiment of the invention; and

FIG. 3 is a diagram illustrating an exemplary embodiment of the invention.

### DETAILED DESCRIPTION OF THE PREFERRED EMBODIMENTS

Various method are provided in order to make email addresses browseable. These methods will be presented in turn.

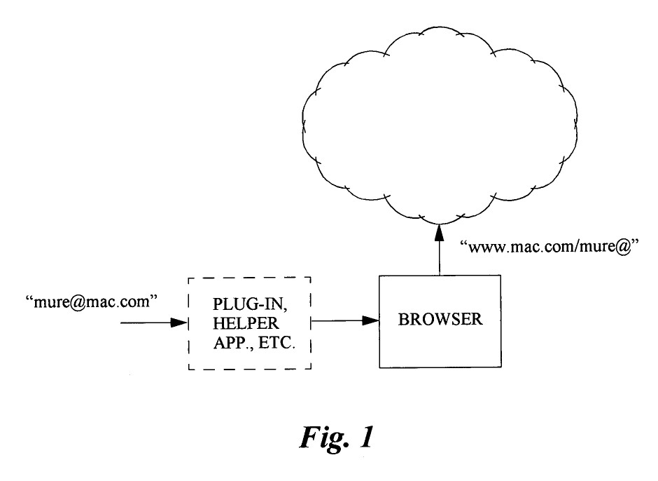

Referring to FIG. 1, one method involves entering, either directly or indirectly, an email address (or a predicable variant thereof) into a browser as the desired URL. The browser, a browser plug-in, a helper application, or the like, transparently reformats the email address into a conventional URL. For example, the email address “mure@mac.com” might be reformatted into “www.mac.com/mure@.” In this example, the character @ is used to identify the desired web page as a personal web page. The helper application may be a desktop widget, toolbar, etc. This method has the advantage of universality. That is, any internet service provider may offer personal web pages that are accessed using this method.

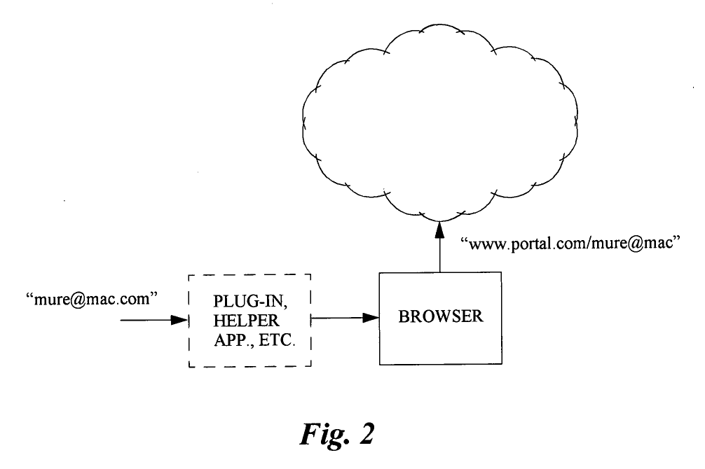

Referring to FIG. 2, another method involves a web portal. An email address (or predictable variant thereof) is entered, directly or indirectly, into the browser. Again, the browser, a browser plug-in, a helper application, or the like, transparently reformats the email address into a conventional URL. In this instance, however, the URL has as its domain not the domain of the email address but the domain of the portal. For example, the email address “mure@mac.com” might be reformatted into “www.portal.com/mure@mac.”

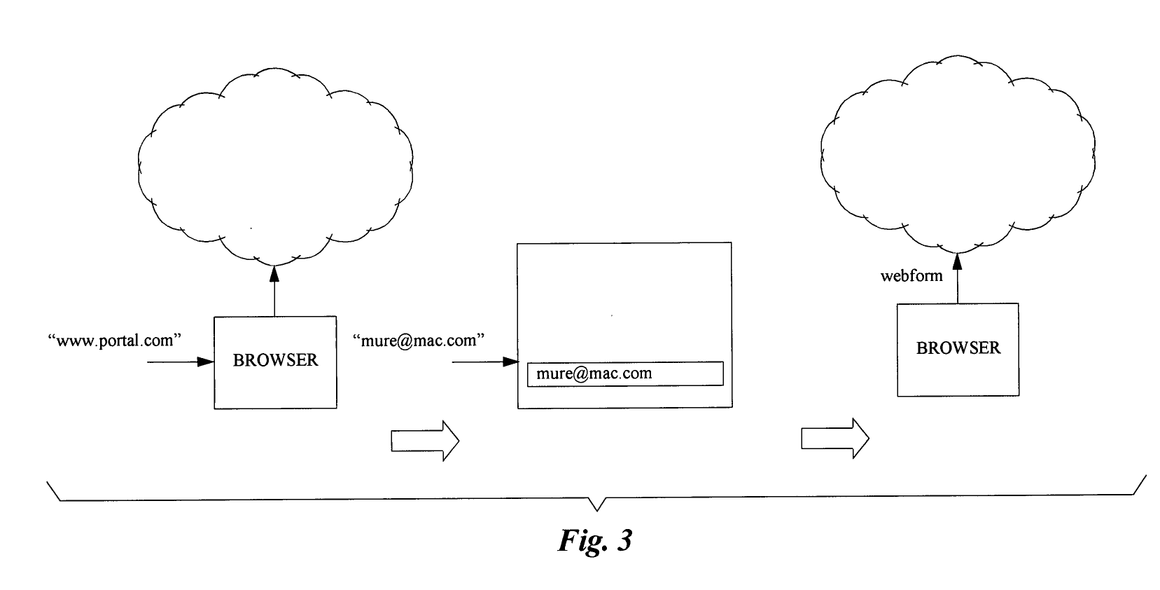

Referring to FIG. 3, another method uses a web form or the like. The user navigates to a known web site, and a web form is presented. An email address is entered into the web form. A lookup operation is performed, and a corresponding web page is displayed. The correspondence between the email address and the web page may have been registered previously or may be determined otherwise.

In the foregoing method, a user may register multiple email addresses in correspondence to a single web page. A further useful feature may be to provide searching capability with respect to registered email addresses. For example, if one wishes to locate John Doe known to have worked at Acme Corp., a search could be performed on “Doe” and “Acme” in the email string.

In all of the foregoing methods, it is not necessary that an email address be current. An old email address may be used to locate a web page giving a current web page address. Furthermore, in all of the foregoing methods, known redirect techniques may be used. The actual URL of a target web page and the location of the server on which it is stored are therefore arbitrary and unconstrained. Known techniques may be used to provide “public” access to select information (e.g., business-card-type information) and “private” access to other information. User control may be provided such that a user may no longer be found using one or more (or any) email addresses.

It will be appreciated by those of ordinary skill in the art that the invention can be embodied in other specific forms without departing from the spirit or essential character thereof. The presently disclosed embodiments are therefore considered in all respects to be illustrative and not restrictive. The scope of the invention is indicated by the appended claims rather than the foregoing description, and all changes which come within the meaning and range of equivalents thereof are intended to be embraced therein.

What is claimed is:

1. A method of retrieving information comprising:
receiving an email address or a predictable variant thereof based on text input into a browser; and
in response thereto, causing to be displayed a web page or a link to a web page that includes information by or about an owner of the email address.
